(19) United States
(12) Patent Application Publication
(10) Pub. No.: US 2024/0222592 A1
(43) Pub. Date: Jul. 4, 2024

(54) BATTERY INFORMATION GENERATION METHOD AND GENERATION SYSTEM

(71) Applicant: Ningde Amperex Technology Limited, Ningde (CN)

(72) Inventors: Jinqiang CHEN, Ningde (CN); Xiaofeng QIAO, Ningde (CN); Zhenchuan CHEN, Ningde (CN); Feide YU, Ningde (CN)

(73) Assignee: Ningde Amperex Technology Limited, Ningde (CN)

(21) Appl. No.: 18/602,573

(22) Filed: Mar. 12, 2024

Related U.S. Application Data
(63) Continuation of application No. PCT/CN2021/118008, filed on Sep. 13, 2021.

(51) Int. Cl. H01M 4/04; H01M 10/0587

(52) U.S. Cl. CPC H01M 4/04; H01M 10/0587

(57) ABSTRACT

A battery information generation method and a generation system. The method includes: a first stage: generating a first number of first identifiers on a surface of metal foil at first intervals, so that a region between the first intervals is divided into the first number of electrode plate regions, and each electrode plate region corresponds to one first identifier; and obtaining first information, and establishing a binding relationship between each first identifier and the first information of the corresponding electrode plate region; and a subsequent stage: obtaining stage information of the electrode plate region in at least one stage separately, and establishing a binding relationship between the first identifier of the at least one stage and the stage information of the corresponding electrode plate region.

### CROSS REFERENCE TO THE RELATED APPLICATIONS

This application is a continuation application of International Application No. PCT/CN2021/118008, filed on Sep. 13, 2021, the contents of which are incorporated herein by reference in its entirety.

### TECHNICAL FIELD

This application relates to the technical field of battery manufacturing, and in particular, to a battery information generation method and generation system.

### BACKGROUND

Currently, a battery production process typically includes stages such as slurry preparation—metal foil winding stack unwinding—coating—cold pressing—slitting—winding or stacking. In the coating stage, an active material is applied onto a surface of the metal foil to form an active material layer. In the cold-pressing stage, the metal foil coated with an active material layer is cold-pressed. In the slitting stage, the relative wide cold-pressed metal foil is cut into a plurality of narrower winding stacks along a first direction, and the winding stacks are readily available for preparing electrode plates. After each stage such as coating, cold-pressing, and slitting, the material is rewound to obtain the corresponding winding stacks.

However, the electrode cannot be traced back to the information about the battery production process.

### SUMMARY

An objective of some embodiments of this application is to provide a battery information generation method and generation system to generate traceable information for each electrode plate and make information traceable to a more detailed level.

A first aspect of some embodiments of this application provides a battery information generation method. The method includes: a first stage: generating a first number of first identifiers on a surface of metal foil at first intervals, so that a region between the first intervals is divided into the first number of electrode plate regions, and each electrode plate region corresponds to one first identifier; and obtaining first information on each electrode plate region, and establishing a binding relationship between each first identifier and the first information of the corresponding electrode plate region; and a subsequent stage: obtaining stage information of the electrode plate region in at least one stage separately, and establishing a binding relationship between the first identifier of the at least one stage and the stage information of the corresponding electrode plate region.

Some embodiments of this application achieve the following technical effects: in the first stage, the first number of first identifiers are generated on the surface of the metal foil at the first intervals, so that a region between the first intervals is divided into the first number of electrode plate regions, and each electrode plate region corresponds to one first identifier. In this way, in the subsequent stage, a binding relationship is established between the electrode plate region information generated in at least one stage and the first identifier, thereby enabling establishment of traceable information in battery production stages by using an electrode plate as a minimum unit, making information traceable to a more detailed level, making it convenient to ascertain quality problems more accurately, improving the yield rate of batteries, reducing scrapped materials in a production process, and reducing production cost of manufacturers.

In some embodiments of this application, in the subsequent stage, the obtaining stage information of the electrode plate region in at least one stage separately, and establishing a binding relationship between the first identifier of the at least one stage and the stage information of the corresponding electrode plate region include at least one of the following steps: (i) a second stage: obtaining, after an active material layer is formed in a region between the first intervals, second information on the active material layer in the electrode plate region, and establishing a binding relationship between the first identifier and the second information of the corresponding electrode plate region; or (ii) a third stage: obtaining, after an active material layer is cold-pressed, third information on the cold-pressed active material layer in the electrode plate region, and establishing a binding relationship between the first identifier and the third information of the corresponding electrode plate region; or (iii) a fourth stage: obtaining, after the metal foil is split into the first number of electrode plate winding stacks along a first direction of the metal foil, fourth information on each electrode plate winding stack to which an electrode plate region belongs, and establishing a binding relationship between the first identifier and the fourth information of the corresponding electrode plate region.

In some embodiments of this application, the method further includes an undercoating stage before the first stage, and the undercoating stage includes: disposing an undercoat in a partial region of a surface of the metal foil, and then, in the first stage, affixing the first identifier onto a surface, uncoated with the undercoat, of the metal foil.

In some embodiments of this application, the method further includes: obtaining a winding stack identifier used for identifying a metal foil winding stack, and establishing a binding relationship between the first identifier and the winding stack identifier, thereby making information traceable to a more detailed level.

In some embodiments of this application, the step of generating a first number of first identifiers on a surface of metal foil at first intervals includes: setting, in a case that a battery assumes a jelly-roll structure, the first intervals along a first direction of the metal foil, and generating the first number of first identifiers in the first interval along a second direction of the metal foil; or, setting, in a case that a battery assumes a stacked structure, the first intervals along a second direction of the metal foil, and generating the first number of first identifiers in the first interval along a first direction of the metal foil. These embodiments of this application can establish traceable information in different battery production stages by using an electrode plate as a minimum unit for batteries of a jelly-roll structure and batteries of a stacked structure separately, thereby making information traceable to a more detailed level.

In some embodiments of this application, the method further includes: generating, after a positive electrode plate and a negative electrode plate are wound or stacked to form an electrode assembly, a second identifier corresponding to the electrode assembly, and establishing a binding relationship between the second identifier and the first identifiers of the positive electrode plate and negative electrode plate that constitute the electrode assembly. In this way, when information needs to be traced for a battery containing the jelly-roll electrode assembly or stacked-type electrode assembly, the first identifiers of the positive electrode plate and negative electrode plate constituting the electrode assembly can be traced based on the second identifier on the electrode assembly, so as to obtain the production information of the positive electrode plate and negative electrode plate, and make battery information traceable to a more detailed level.

In some embodiments of this application, the step of generating a first number of first identifiers on a surface of metal foil at first intervals includes: generating, by inkjet marking or laser marking, a number of first identifiers in a first region formed by a first interval, where the number of first identifiers corresponds to a number of electrode plate winding stacks into which a metal foil winding stack is slit.

In some embodiments of this application, the method further includes: obtaining, in the second stage and/or the third stage, in a case that a mass of the active material layer in a current electrode plate region fails to be obtained, an average value of masses of active material layers in two electrode plate regions adjacent to the current electrode plate region along the first direction of the metal foil, and using the average value as the mass of the active material layer in the current electrode plate region. In this way, even when the mass of the active material layer in an electrode plate region fails to be measured, the mass of the current active material layer can still be determined based on the mass of the active material layers in the adjacent electrode plate regions, thereby improving the degree of intelligence in generating the traceable information, and being more conducive to subsequent information tracing.

In some embodiments of this application, the method further includes: uploading the first information, the binding relationship between the first identifier and the first information of the corresponding electrode plate region, the second information, the binding relationship between the first identifier and the second information of the corresponding electrode plate region, the third information, the binding relationship between the first identifier and the third information of the corresponding electrode plate region, the fourth information, the binding relationship between the first identifier and the fourth information of the corresponding electrode plate region, metal foil winding stack information, and a binding relationship between the first identifier and a winding stack identifier to a server, thereby further facilitating subsequent information tracing.

In some embodiments of this application, the first information includes at least one of a winding stack number, a product model, a winding stack length, production time, production equipment, production personnel, a number of electrode plate winding stacks into which a metal foil winding stack is slit, a total number of electrode plates, or an electrode plate length; the second information includes at least one of the winding stack number, the product model, the winding stack length, the production time, the production equipment, the production personnel, the number of electrode plate winding stacks into which a metal foil winding stack is slit, the total number of electrode plates, the electrode plate length, constituents of the active material layer, position coordinates of the active material layer, a coating mass of the active material layer, or a coating thickness of the active material layer; the third information includes at least one of the winding stack number, the product model, the winding stack length, the production time, the production equipment, the production personnel, the number of electrode plate winding stacks into which a metal foil winding stack is slit, the total number of electrode plates, the electrode plate length, or position coordinates or a thickness of the cold-pressed active material layer; and the fourth information includes at least one of the winding stack number, the product model, the winding stack length, the production time, the production equipment, the production personnel, a number of electrode plates in an electrode plate winding stack, or the electrode plate length.

A second aspect of some embodiments of this application provides a battery information generation system. The system includes a first identifier generation apparatus and an information processing apparatus. The identifier generation apparatus is configured to generate, in a first stage, a first number of first identifiers on a surface of metal foil at first intervals, so that a region between the first intervals is divided into the first number of electrode plate regions, and each electrode plate region corresponds to one first identifier. The information processing apparatus is configured to obtain first information of each electrode plate region, and establish a binding relationship between each first identifier and the first information of the corresponding electrode plate region; and in a subsequent stage, obtain stage information of the electrode plate region in at least one stage separately, and establish a binding relationship between the first identifier of the at least one stage and the stage information of the corresponding electrode plate region. By establishing a binding relationship between the information generated in a subsequent stage and the first identifier, this application enables establishment of traceable information in different battery production stages by using an electrode plate as a minimum unit, makes information traceable to a more detailed level, makes it convenient to ascertain quality problems more accurately, improves the yield rate of batteries, reduces scrapped materials in a production process, and reduces production cost of manufacturers.

In some embodiments of this application, the information processing apparatus is specifically configured to: obtain, in a second stage, after an active material layer is formed in a region between the first intervals, second information on the active material layer in the electrode plate region, and establish a binding relationship between the first identifier and the second information of the corresponding electrode plate region; or obtain, in a third stage, after an active material layer is cold-pressed, third information on the cold-pressed active material layer in the electrode plate region, and establish a binding relationship between the first identifier and the third information of the corresponding electrode plate region; or obtain, in a fourth stage, after the metal foil is split into the first number of electrode plate winding stacks along a first direction of the metal foil, fourth information on each electrode plate winding stack to which an electrode plate region belongs, and establish a binding relationship between the first identifier and the fourth information of the corresponding electrode plate region. These embodiments of this application enable establishment of traceable information in each production stage by using an electrode plate as a minimum unit, thereby making information traceable to a more detailed level, making it convenient to ascertain quality problems more accurately, improving the yield rate of batteries, reducing scrapped materials in a production process, and reducing production cost of manufacturers.

In some embodiments of this application, the information processing apparatus is further configured to: obtain a winding stack identifier used for identifying a metal foil winding stack, and establish a binding relationship between the first identifier and the winding stack identifier. These embodiments of this application can trace the winding stack identifier by scanning the first identifier during information tracing, thereby finding the information on the metal winding stack to which an electrode plate belongs, and further improving the detailed level of information tracing.

In some embodiments of this application, the first identifier generation apparatus is specifically configured to: set, in a case that a battery assumes a jelly-roll structure, the first intervals along a first direction of the metal foil, and generate the first number of first identifiers in a first interval along a second direction of the metal foil; or set, in a case that a battery assumes a stacked structure, the first intervals along a second direction of the metal foil, and generate the first number of first identifiers in a first interval along a first direction of the metal foil. These embodiments of this application can establish traceable information in different battery production stages by using an electrode plate as a minimum unit for batteries of a jelly-roll structure or batteries of a stacked structure, thereby making information traceable to a more detailed level for the batteries of a jelly-roll structure or batteries of a stacked structure.

In some embodiments of this application, the system further includes a second identifier generation apparatus, configured to generate, after a positive electrode plate and a negative electrode plate are wound or stacked to form an electrode assembly, a second identifier corresponding to the electrode assembly, and establish a binding relationship between the second identifier and the first identifiers of the positive electrode plate and negative electrode plate that constitute the electrode assembly, thereby making information traceable to a more detailed level for the batteries of a jelly-roll structure or batteries of a stacked structure.

In some embodiments of this application, the first identifier generation apparatus and/or the second identifier generation apparatus is an inkjet marking device or a laser marking machine.

In some embodiments of this application, the information processing apparatus is specifically configured to: obtain, in the second stage and/or the third stage, in a case that a mass of the active material layer in a current electrode plate region fails to be obtained, an average value of masses of active material layers in two electrode plate regions adjacent to the current electrode plate region along the first direction of the metal foil, and use the average value as the mass of the active material layer in the current electrode plate region. These embodiments improve the degree of intelligence in generating the traceable information, and are more conducive to subsequent information tracing.

In some embodiments of this application, the system further includes: an information uploading apparatus, configured to upload the first information, the binding relationship between the first identifier and the first information of the corresponding electrode plate region, the second information, the binding relationship between the first identifier and the second information of the corresponding electrode plate region, the third information, the binding relationship between the first identifier and the third information of the corresponding electrode plate region, the fourth information, the binding relationship between the first identifier and the fourth information of the corresponding electrode plate region, metal foil winding stack information, and a binding relationship between the first identifier and a winding stack identifier to a server, thereby further facilitating subsequent information tracing.

In some embodiments of this application, the first information includes at least one of a winding stack number, a product model, a winding stack length, production time, production equipment, production personnel, a number of electrode plate winding stacks into which a metal foil winding stack is slit, a total number of electrode plates, or an electrode plate length; the second information includes at least one of the winding stack number, the product model, the winding stack length, the production time, the production equipment, the production personnel, the number of electrode plate winding stacks into which a metal foil winding stack is slit, the total number of electrode plates, the electrode plate length, constituents of the active material layer, position coordinates of the active material layer, a coating mass of the active material layer, or a coating thickness of the active material layer; the third information includes at least one of the winding stack number, the product model, the winding stack length, the production time, the production equipment, the production personnel, the number of electrode plate winding stacks into which a metal foil winding stack is slit, the total number of electrode plates, the electrode plate length, or position coordinates or a thickness of the cold-pressed active material layer; and the fourth information includes at least one of the winding stack number, the product model, the winding stack length, the production time, the production equipment, the production personnel, a number of electrode plates in an electrode plate winding stack, or the electrode plate length.

In the battery information generation method and generation system provided in some embodiments of this application, in the first stage, the first number of first identifiers are generated on the surface of the metal foil at the first intervals, so that a region between the first intervals is divided into the first number of electrode plate regions, and each electrode plate region corresponds to one first identifier. In this way, in the subsequent stage, a binding relationship is established between the electrode plate region information generated in at least one stage and the first identifier, thereby enabling establishment of traceable information in battery production stages by using an electrode plate as a minimum unit, making information traceable to a more detailed level, making it convenient to ascertain quality problems more accurately, improving the yield rate of batteries, reducing scrapped materials in a production process, and reducing production cost of manufacturers. Definitely, implementation of any one product or method according to this application does not necessarily achieve all of the foregoing advantages concurrently.

### BRIEF DESCRIPTION OF DRAWINGS

To describe the technical solutions in this application or the prior art more clearly, the following outlines the drawings to be used in the embodiments of this application or the prior art. Evidently, the drawings outlined below are merely a part of embodiments of this application.

FIG. 1A is a schematic flowchart of a battery information generation method according to an embodiment of this application;

FIG. 1B is a schematic diagram of dividing a surface of metal foil into electrode plate regions and generating first identifiers according to an embodiment of this application;

FIG. 2 is a schematic flowchart of another battery information generation method according to an embodiment of this application;

FIG. 3A is a schematic diagram of slit metal foil coated with an active material layer in a battery of a jelly-roll structure according to an embodiment of this application;

FIG. 3B is a schematic diagram of slit metal foil coated with an active material layer in a battery of a stacked structure according to an embodiment of this application;

FIG. 4 is a schematic diagram of a measurement path of an X-ray measurement instrument for a battery of a jelly-roll structure;

FIG. 5 is a schematic diagram of a measurement path of an X-ray measurement instrument for a battery of a stacked structure; and

FIG. 6 is a schematic structural diagram of a battery information generation system according to an embodiment of this application.

### DETAILED DESCRIPTION

To make the objectives, technical solutions, and advantages of this application clearer, the following describes this application in further detail with reference to drawings and embodiments. Evidently, the described embodiments are merely a part of but not all of the embodiments of this application. All other embodiments derived by a person of ordinary skill in the art based on the embodiments of this application without making any creative efforts still fall within the protection scope of this application.

In the related art, a typical practice is to generate only the information on a corresponding winding stack during rewinding in each stage. For example, after the slitting stage, the information corresponding to each electrode plate winding stack is generated during rewinding. If a problem occurs in a battery, the problem can only be traced back to the electrode plate winding stack information based on the battery information, but cannot be traced back to the information on a specific electrode plate. Consequently, all the electrode plates of the electrode plate winding stack may be identified as faulty electrode plates and scrapped, thereby increasing scrapped materials and increasing production cost of manufacturers.

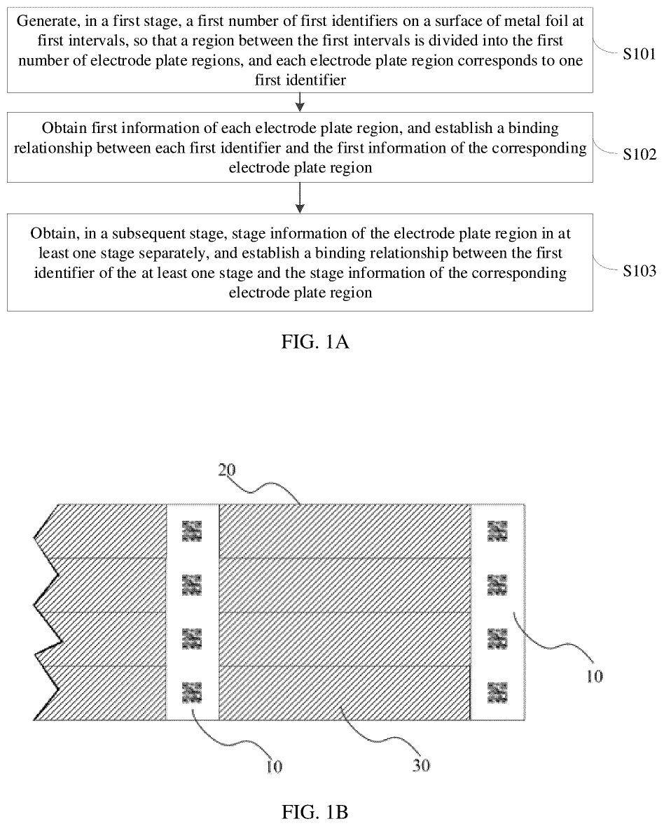

In view of the situation above, an embodiment of this application provides a battery information generation method. As shown in FIG. 1A, the method includes the following steps:
S101: Generate, in a first stage, a first number of first identifiers on a surface of metal foil at first intervals, so that a region between the first intervals is divided into the first number of electrode plate regions, and each electrode plate region corresponds to one first identifier.

After the metal foil winding stack used for manufacturing electrode plates is unwound, the first stage begins. The first stage may be an inkjet marking stage, that is, a stage of forming a first identifier on the surface of the metal foil. The metal foil serves as a current collector of an electrode plate. The metal foil may be copper foil or aluminum foil. Understandably, after the metal foil winding stack is unwound, the winding stack moves forward with the rotation of the roller. In some embodiments of this application, a first direction is defined as a moving direction of the metal foil. That is, the first direction is a machine direction (Machine Direction). A direction perpendicular to the moving direction of the metal foil is a second direction of the metal foil. That is, the second direction is a transverse direction (Transverse Direction, perpendicular to the machine direction).

The metal foil winding stack is relatively wide, and needs to be slit into a plurality of thinner winding stacks to facilitate the subsequent production of electrode plates.

FIG. 1B is a schematic diagram of dividing a surface of metal foil into electrode plate regions and generating first identifiers according to an embodiment of this application. Understandably, the first identifiers may be generated at first intervals on the metal surface, and therefore, a plurality of electrode plate regions can be logically defined in the regions between the first intervals in the first stage. In an implementation, referring to FIG. 1B, on the surface of the metal foil, a plurality of first identifiers are set in a region corresponding to the first interval, and the region is not coated with an active material. Therefore, a region corresponding to a first interval in the metal foil may be referred to as a first region 10. A region between the first intervals in the metal foil is a region to be coated with the active material layer. Therefore, a region between the first intervals may be referred to as a second region 20 (a region indicated by oblique lines in FIG. 1B). As an example, if the metal foil is slit into 4 strips in the second direction, then one second region is divided into 4 electrode plate regions 30 along the second direction. Each of the 4 electrode plate regions corresponds to one first identifier, as shown in FIG. 1B.

In this embodiment of this application, the first number of first identifiers are generated in the first region. The number of first identifiers in the first region may be determined based on the number of strips into which the metal foil is slit in the second direction. For example, referring to FIG. 1B, if the metal foil is slit into 4 strips in the second direction, then 4 first identifiers may be generated in one first region 10. In this way, one second region 20 is divided into 4 electrode plate regions 30, and each electrode plate region 30 corresponds to one first identifier.

The first number is not particularly limited herein, and may be set based on the width of the metal foil winding stack and the width of the electrode plate into which the metal foil is to be slit, as long as the objectives of this application can be achieved. The first identifier is not particularly limited herein, and may be, but is not limited to, QR code, barcode, or another form of identifier, as long as the objectives of this application can be achieved. The metal foil winding stack in this embodiment of this application may be a copper foil winding stack, an aluminum foil winding stack, or a winding stack of another metal material. The copper foil winding stack is typically configured to produce negative electrode plates, and the aluminum foil winding stack is typically configured to produce positive electrode plates. The battery in this embodiment of this application may be a lithium-ion battery of diverse structures, such as a jelly-roll lithium-ion battery or a stacked-type lithium-ion battery.
S102: Obtain first information of each electrode plate region, and establish a binding relationship between each first identifier and the first information of the corresponding electrode plate region.

In this embodiment of this application, after the second region is divided into the first number of electrode plate regions, the information of the electrode plate regions can be obtained as the first information. Each electrode plate region corresponds to one first identifier. Therefore, a binding relationship can be established between each first identifier and the first information of the corresponding electrode plate region. In this way, during information tracing, the first information can be obtained by scanning the first identifier. The first information is the information of the electrode plate region corresponding to the scanned first identifier.

The content of the first information is not particularly limited herein, as long as the objectives of this embodiment of this application can be fulfilled. For example, the first information may include at least one of the winding stack number, the product model, the winding stack length, the production time, the production equipment, the production personnel, the number of electrode plate winding stacks into which a metal foil winding stack is slit, the total number of electrode plates, or the electrode plate length.
S103: Obtain, in a subsequent stage, stage information of the electrode plate region in at least one stage separately, and establish a binding relationship between the first identifier of the at least one stage and the stage information of the corresponding electrode plate region.

In each subsequent stage of battery production, the electrode plate region may be processed accordingly to generate stage information of the electrode plate region in each stage. As an example, in the second stage, the electrode plate region is coated with an active material to form an active material layer, and therefore, information on the active material layer in the electrode plate region is generated. The information on the active material layer in the electrode plate region is the stage information of the electrode plate region in the second stage. In the third stage, the active material layer is cold-pressed, and therefore, information on the cold-pressed active material layer in the electrode plate region is generated. The information on the cold-pressed active material layer in the electrode plate region is the stage information of the electrode plate region in the third stage.

Each electrode plate region corresponds to one first identifier, and the information of the corresponding electrode plate region is generated in each stage. Therefore, for each stage, a binding relationship can be established between the first identifier of this stage and the information of the corresponding electrode plate region. Based on this, this embodiment of this application can obtain the stage information of the electrode plate region in at least one stage separately, and establish a binding relationship between the first identifier of the at least one stage and the stage information of the corresponding electrode plate region to facilitate trace the information to each stage.

In the battery information generation method provided in some embodiments of this application, in the first stage, the first number of first identifiers are generated on the surface of the metal foil at the first intervals, so that a region between the first intervals is divided into the first number of electrode plate regions, and each electrode plate region corresponds to one first identifier. In this way, in the subsequent stage, a binding relationship is established between the electrode plate region information generated in at least one stage and the first identifier, thereby enabling establishment of traceable information in battery production stages by using an electrode plate as a minimum unit, making information traceable to a more detailed level, making it convenient to ascertain quality problems more accurately, improving the yield rate of batteries, reducing scrapped materials in a production process, and reducing production cost of manufacturers.

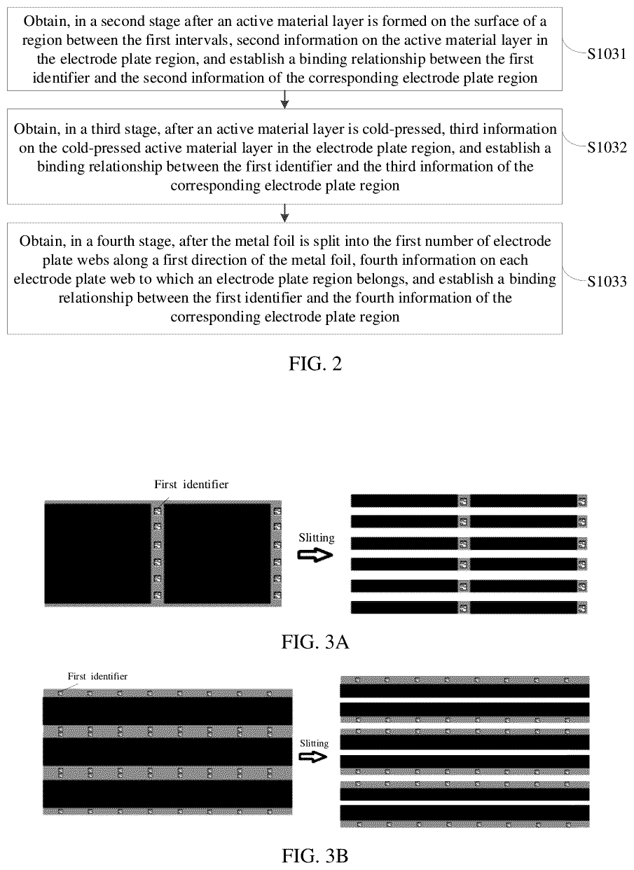

In an implementation, as shown in FIG. 2, step S103 includes the following substeps:
S1031: Obtain, in a second stage after an active material layer is formed on the surface of a region between the first intervals, second information on the active material layer in the electrode plate region, and establish a binding relationship between the first identifier and the second information of the corresponding electrode plate region.

The second stage in this embodiment of this application may be a coating stage. The second stage is typically a stage of applying an active material slurry onto the surface of the metal foil to form an active material layer. For example, a positive active material slurry is applied onto the surface of aluminum foil to form a positive active material layer, or a negative active material slurry is applied onto the surface of copper foil to form a negative active material layer.

In this embodiment of this application, after an active material layer is formed in the second region, that is, the region between the first intervals on the surface of the metal foil, the information on the active material layer in each electrode plate region in the second region can be obtained, denoted as second information. Each electrode plate region corresponds to one first identifier. Therefore, a binding relationship can be established between each first identifier and the second information of the corresponding electrode plate region. In this way, during information tracing, the second information can be obtained by scanning the first identifier. The second information is the information on the active material layer of the electrode plate region corresponding to the scanned first identifier.

The content of the second information is not particularly limited herein, as long as the objectives of this embodiment of this application can be fulfilled. For example, the second information may include at least one of the winding stack number, the product model, the winding stack length, the production time, the production equipment, the production personnel, the number of electrode plate winding stacks into which a metal foil winding stack is slit, the total number of electrode plates, the electrode plate length, constituents of the active material layer, position coordinates of the active material layer, the coating mass of the active material layer, or the coating thickness of the active material layer.
S1032: Obtain, in a third stage, after an active material layer is cold-pressed, third information on the cold-pressed active material layer in the electrode plate region, and establish a binding relationship between the first identifier and the third information of the corresponding electrode plate region.

The third stage in this embodiment of this application may be a cold-pressing stage. The third stage is typically a stage of cold-pressing the metal foil coated with the active material layer by using a pressure roller. This stage not only makes the active material layer adhere to the metal foil more closely, but also regulate the process parameters such as the porosity and compaction density of the active material layer.

In this embodiment of this application, after the active material layer is cold-pressed, the information on the cold-pressed active material layer in each electrode plate region may be obtained, denoted as third information. Each electrode plate region corresponds to one first identifier. Therefore, a binding relationship can be established between each first identifier and the third information of the corresponding electrode plate region. In this way, during information tracing, the third information can be obtained by scanning the first identifier. The third information is the information on the cold-pressed active material layer of the electrode plate region corresponding to the first identifier.

The content of the third information is not particularly limited herein, as long as the objectives of this embodiment of this application can be fulfilled. For example, the third information may include at least one of the winding stack number, the product model, the winding stack length, the production time, the production equipment, the production personnel, the number of electrode plate winding stacks into which a metal foil winding stack is slit, the total number of electrode plates, the electrode plate length, or position coordinates or coating thickness of the cold-pressed active material layer.
S1033: Obtain, in a fourth stage, after the metal foil is split into the first number of electrode plate winding stacks along a first direction of the metal foil, fourth information on each electrode plate winding stack to which an electrode plate region belongs, and establish a binding relationship between the first identifier and the fourth information of the corresponding electrode plate region.

The fourth stage of this embodiment of this application may be a slitting stage. The fourth stage is typically to slit the cold-pressed metal foil into a preset number of strips along the first direction of the metal foil, so as to obtain several electrode plate winding stacks of a smaller width. FIG. 3A is a schematic diagram of slit metal foil coated with an active material layer in a battery of a jelly-roll structure. As can be seen from FIG. 3A, the metal foil winding stack is slit into 6 narrower electrode plate winding stacks. Each electrode plate winding stack includes electrode plate regions spaced apart along the first direction. The electrode plate regions are to be cut into corresponding electrode plates. FIG. 3B is a schematic diagram of slit metal foil coated with an active material layer in a battery of a stacked structure. As can be seen from FIG. 3B, the metal foil winding stack is also slit into 6 narrower electrode plate winding stacks.

In this embodiment of this application, after the metal foil coated with the active material layer is slit into the first number of electrode plate winding stacks, the information on the electrode plate winding stack to which the electrode plate region belongs is obtained, denoted as fourth information. Each electrode plate region corresponds to one first identifier. Therefore, a binding relationship can be established between each first identifier and the fourth information of the corresponding electrode plate region. In this way, during information tracing, the fourth information can be obtained by scanning the first identifier. The fourth information is the information on the electrode plate winding stack to which the electrode plate region corresponding to the first identifier belongs. This embodiment of this application enables establishment of traceable information in each battery production stage by using the electrode plate as a minimum unit, thereby making information traceable to a more detailed level, and making it convenient to ascertain quality problems more accurately. Definitely, the subsequent stages in an embodiment of this application may include, but are not limited to, the stage described above.

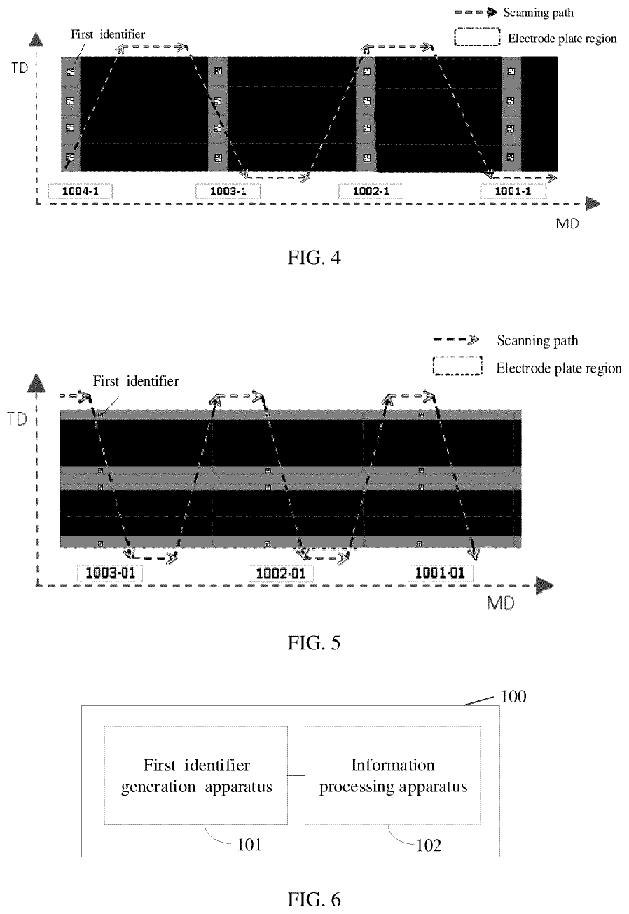

In measuring the mass and thickness of the active material layer, an X-ray measurement instrument may be used to measure points along a preset path on the surface of the metal foil coated with an active material layer. FIG. 4 is a schematic diagram of a measurement path for a battery of a jelly-roll structure, and FIG. 5 is a schematic diagram of a measurement path for a battery of a stacked structure. The X-ray measurement instrument scans each electrode plate region along a path indicated by the dashed arrow in the drawing, and measures the thickness and mass at a specified point in each electrode plate region. If a plurality of points are obtained in one electrode plate region, an average value of the measurement results at the plurality of points is calculated. If no point is obtained in an electrode plate region, an average value of the measurement results of left and right electrode plate regions adjacent to this electrode plate region is calculated and used as a measurement result of this electrode plate region. FIG. 4 and FIG. 5 further show the spaced active material layers, the position coordinates of each active material layer (for example, 1001-1, and 1001-2), the blank foil region, the first identifier in the blank foil region, and the logically defined electrode plate regions indicated by dashed lines.

In an implementation, the method further includes: obtaining a winding stack identifier used for identifying a metal foil winding stack, and establishing a binding relationship between the first identifier and the winding stack identifier.

The start end of the metal foil winding stack typically carries a winding stack identifier such as a serial number used for identifying the metal foil winding stack. This embodiment of this application can obtain the winding stack identifier, for example, by scanning the QR code of the winding stack by use of a code scanner; and can establish a binding relationship between the first identifier and the winding stack identifier. In this way, during information tracing, the winding stack identifier can be traced by scanning the first identifier, thereby finding the information on the metal winding stack to which an electrode plate belongs, and further improving the detailed level of information tracing. The steps in this embodiment may be performed before step S101.

In an optional implementation of an embodiment of this application, in a case that the battery assumes a jelly-roll structure, referring to FIG. 4, the first intervals may be set along the first direction of the metal foil. The first number of first identifiers may be generated in a first interval along the second direction of the metal foil. In this way, for batteries of a jelly-roll structure, traceable information can be established in different battery production stages of the jelly-roll batteries by using the electrode plate as a minimum unit, thereby making information traceable to a more detailed level.

In an optional implementation of an embodiment of this application, in a case that the battery assumes a jelly-roll structure, the method may further include: generating, after a positive electrode plate and a negative electrode plate are wound to form an electrode assembly in a winding stage, a second identifier corresponding to the electrode assembly, and establishing a binding relationship between the second identifier and the first identifiers of the positive electrode plate and negative electrode plate that constitute the electrode assembly.

The electrode plate in this embodiment of this application may include a positive electrode plate and a negative electrode plate. Correspondingly, both the positive electrode plate and the negative electrode plate may carry a first identifier. After a positive electrode plate and a negative electrode plate are wound to form an electrode assembly, a second identifier corresponding to the electrode assembly may be generated. For example, the second identifier may be formed by spraying an inkjet mark onto the surface of the electrode assembly. The second identifier is used for uniquely identifying the electrode assembly. A binding relationship is established between the second identifier and the first identifiers of the positive electrode plate and negative electrode plate that constitute the electrode assembly. In this way, when information needs to be traced for a battery containing the jelly-roll electrode assembly, the first identifiers of the positive electrode plate and negative electrode plate constituting the electrode assembly can be traced based on the second identifier on the electrode assembly, so as to obtain the production information of the positive electrode plate and negative electrode plate, and make information traceable to a more detailed level for the battery of a jelly-roll structure.

In an optional implementation of an embodiment of this application, in a case that the battery assumes a stacked structure, the first intervals may be set along the second direction of the metal foil. The first number of first identifiers may be generated in the first interval along the first direction of the metal foil. In this way, for batteries of a stacked structure, traceable information can be established in different battery production stages of the stacked-type batteries by using the electrode plate as a minimum unit, thereby making information traceable to a more detailed level.

In an optional implementation of an embodiment of this application, in a case that the battery assumes a stacked structure, the method may further include: generating, after a plurality of positive electrode plates and a plurality of negative electrode plates are stacked to form an electrode assembly in a stacking stage, a second identifier corresponding to the electrode assembly, and establishing a binding relationship between the second identifier and the first identifiers of the plurality of positive electrode plates and the plurality of negative electrode plates that constitute the electrode assembly.

The stacked-type battery may include a plurality of stacked positive electrode plates and negative electrode plates. Correspondingly, all the positive electrode plates and the negative electrode plates may carry a first identifier. After the plurality of positive electrode plates and the plurality of negative electrode plates are stacked to form an electrode assembly, a second identifier corresponding to the electrode assembly may be generated. For example, the second identifier may be formed by spraying an inkjet mark onto the surface of the electrode assembly. The second identifier is used for uniquely identifying the electrode assembly. A binding relationship is established between the second identifier and the first identifiers of the positive electrode plate and negative electrode plate that constitute the electrode assembly. In this way, when information needs to be traced for a battery containing the stacked-type electrode assembly, the first identifiers of the positive electrode plate and negative electrode plate constituting the electrode assembly can be traced based on the second identifier on the electrode assembly, so as to obtain the production information of the positive electrode plate and negative electrode plate, and make information traceable to a more detailed level for the battery of a stacked structure.

As an optional implementation of an embodiment of this application, if the electrode plate for use in a stacked-type battery needs to be further cut to suit the need of producing a special-shaped battery, the first identifier may be cut away. In this case, a third identifier may be generated on the tab of the electrode plate first, and a binding relationship is established between the third identifier and the first identifier, and then the part that carries the first identifier in the electrode plate is cut away. The third identifier is bound to the winding stack identifier on the surface of the electrode assembly, thereby avoiding the problem that the production information is not traceable due to cutaway of the first identifier, and improving the reliability of information tracing.

The method for generating the first identifier is not particularly limited herein, as long as the objectives of this embodiment of this application can be achieved. For example, a number of first identifiers are generated by inkjet marking or laser marking in a first region formed by a first interval, where the number of first identifiers corresponds to the number of first electrode plate winding stacks into which a metal foil winding stack is slit. In this embodiment of this application, the number of first electrode plate winding stacks into which a metal foil winding stack is slit may be set according to production needs, for example, may be set to 4, 5, 6, 7, 8.

The applicant hereof finds that the data difference between the electrode plate regions distributed along the first direction of the metal foil is small. Based on this finding, in an optional implementation of an embodiment of this application, the method may further include: obtaining, in the second stage, in a case that a mass of the active material layer in a current electrode plate region fails to be obtained, an average value of masses of active material layers in two electrode plate regions adjacent to the current electrode plate region along the first direction of the metal foil, and using the average value as the mass of the active material layer in the current electrode plate region. In this way, even when the X-ray measurement instrument fails to measure the mass of the active material layer in an electrode plate region, the mass of the current active material layer can still be determined based on the mass of the active material layers in the adjacent electrode plate regions, thereby improving the degree of intelligence in generating the traceable information, and being more conducive to subsequent information tracing.

Based on the finding that the data difference between the electrode plate regions distributed along the first direction of the metal foil is small, the method may further include: obtaining, in the third stage, in a case that a thickness of the active material layer in a current electrode plate region fails to be obtained, an average value of thicknesses of active material layers in two electrode plate regions adjacent to the current electrode plate region along the first direction of the metal foil, and using the average value as the thickness of the active material layer in the current electrode plate region. In this way, even when the X-ray measurement instrument fails to measure the thickness of the active material layer in an electrode plate region, the thickness of the current active material layer can still be determined based on the thickness of the active material layers in the adjacent electrode plate regions, thereby improving the degree of intelligence in generating the traceable information, and being more conducive to subsequent information tracing. Based on the same principles, in the third stage, even if the thickness of the active material layer in the current electrode plate region fails to be obtained, the thickness of the active material layer in the current electrode plate region can still be determined.

In an optional implementation of an embodiment of this application, the method may further include: uploading the first information, the binding relationship between the first identifier and the first information of the corresponding electrode plate region, the second information, the binding relationship between the first identifier and the second information of the corresponding electrode plate region, the third information, the binding relationship between the first identifier and the third information of the corresponding electrode plate region, the fourth information, the binding relationship between the first identifier and the fourth information of the corresponding electrode plate region, metal foil winding stack information, and a binding relationship between the first identifier and a winding stack identifier to a server, thereby enabling the server to store the foregoing information and binding relationships, and further facilitating subsequent information tracing.

In an optional implementation of an embodiment of this application, the first information includes at least one of a winding stack number, a product model, a winding stack length, production time, production equipment, production personnel, a number of electrode plate winding stacks into which a metal foil winding stack is slit, a total number of electrode plates, or an electrode plate length; the second information includes at least one of the winding stack number, the product model, the winding stack length, the production time, the production equipment, the production personnel, the number of electrode plate winding stacks into which a metal foil winding stack is slit, the total number of electrode plates, the electrode plate length, constituents of the active material layer, position coordinates of the active material layer, a coating mass of the active material layer, or a coating thickness of the active material layer; the third information includes at least one of the winding stack number, the product model, the winding stack length, the production time, the production equipment, the production personnel, the number of electrode plate winding stacks into which a metal foil winding stack is slit, the total number of electrode plates, the electrode plate length, or position coordinates or a thickness of the cold-pressed active material layer; and the fourth information includes at least one of the winding stack number, the product model, the winding stack length, the production time, the production equipment, the production personnel, a number of electrode plates in an electrode plate winding stack, or the electrode plate length.

In an optional implementation of an embodiment of this application, the method further includes an undercoating stage before the first stage. The undercoating stage is to apply an undercoat onto the surface of the metal foil at specified intervals. The undercoat formed by the undercoating stage can improve the adhesion between the active material layer and the metal foil or fulfill other production purposes. As an example, an undercoat may be applied in the second region. To be specific, an undercoat is applied in a region to be coated with an active material layer on a surface of the metal foil, and then, in the first stage, the first identifier is affixed onto a surface, uncoated with the undercoat, of the metal foil. Correspondingly, the first information may further include the information related to the undercoating stage, for example, constituents of the undercoat, and the position coordinates of the undercoat.

An embodiment of this application further provides a battery information generation system. As shown in FIG. 6, the battery information generation system 100 includes a first identifier generation apparatus 101 and an information processing apparatus 102.

The first identifier generation apparatus 101 is configured to generate, in a first stage, a first number of first identifiers on a surface of metal foil at first intervals, so that a region between the first intervals is divided into the first number of electrode plate regions, and each electrode plate region corresponds to one first identifier.

The information processing apparatus 102 is configured to obtain first information of each electrode plate region, and establish a binding relationship between each first identifier and the first information of the corresponding electrode plate region.

In a subsequent stage, obtain stage information of the electrode plate region in at least one stage separately, and establish a binding relationship between the first identifier of the at least one stage and the stage information of the corresponding electrode plate region.

In an implementation, the information processing apparatus is specifically configured to:
obtain, in a second stage, after an active material layer is formed in a region between the first intervals, second information on the active material layer in the electrode plate region, and establish a binding relationship between the first identifier and the second information of the corresponding electrode plate region; or
obtain, in a third stage, after an active material layer is cold-pressed, third information on the cold-pressed active material layer in the electrode plate region, and establish a binding relationship between the first identifier and the third information of the corresponding electrode plate region; or
obtain, in a fourth stage, after the metal foil is split into the first number of electrode plate winding stacks along a second direction of the metal foil, fourth information on each electrode plate winding stack to which an electrode plate region belongs, and establish a binding relationship between the first identifier and the fourth information of the corresponding electrode plate region.

In an implementation, the information processing apparatus is further configured to:
obtain a winding stack identifier used for identifying a metal foil winding stack, and establish a binding relationship between the first identifier and the winding stack identifier.

In an implementation, the first identifier generation apparatus is specifically configured to:
set, in a case that a battery assumes a jelly-roll structure, the first intervals along a first direction of the metal foil, and generate the first number of first identifiers in a first interval along a second direction of the metal foil; or
set, in a case that a battery assumes a stacked structure, the first intervals along a second direction of the metal foil, and generate the first number of first identifiers in a first interval along a first direction of the metal foil.

In an implementation, the system further includes a second identifier generation apparatus. The second identifier generation apparatus is configured to:
generate, after a positive electrode plate and a negative electrode plate are wound or stacked to form an electrode assembly, a second identifier corresponding to the electrode assembly, and establish a binding relationship between the second identifier and the first identifiers of the positive electrode plate and negative electrode plate that constitute the electrode assembly.

In an implementation, the first identifier generation apparatus and/or the second identifier generation apparatus is an inkjet marking device or a laser marking machine, and preferably an inkjet marking device such as an inkjet printer.

In an implementation, the information processing apparatus is specifically configured to:
obtain, in the second stage and/or the third stage, in a case that a mass of the active material layer in a current electrode plate region fails to be obtained, an average value of masses of active material layers in two electrode plate regions adjacent to the current electrode plate region along the first direction of the metal foil, and use the average value as the mass of the active material layer in the current electrode plate region.

In an implementation, the system further includes:
an information uploading apparatus, configured to upload the first information, the binding relationship between the first identifier and the first information of the corresponding electrode plate region, the second information, the binding relationship between the first identifier and the second information of the corresponding electrode plate region, the third information, the binding relationship between the first identifier and the third information of the corresponding electrode plate region, the fourth information, the binding relationship between the first identifier and the fourth information of the corresponding electrode plate region, metal foil winding stack information, and a binding relationship between the first identifier and a winding stack identifier to a server.

In an implementation, the first information includes at least one of the winding stack number, the product model, the winding stack length, the production time, the production equipment, the production personnel, the number of electrode plate winding stacks into which a metal foil winding stack is slit, or the total number of electrode plates.

The second information includes at least one of the winding stack number, the product model, the winding stack length, the production time, the production equipment, the production personnel, the number of electrode plate winding stacks into which a metal foil winding stack is slit, the total number of electrode plates, the electrode plate length, constituents of the active material layer, position coordinates of the active material layer, a coating mass of the active material layer, or a coating thickness of the active material layer.

The third information includes at least one of the winding stack number, the product model, the winding stack length, the production time, the production equipment, the production personnel, the number of electrode plate winding stacks into which a metal foil winding stack is slit, the total number of electrode plates, the electrode plate length, or position coordinates or thickness of the cold-pressed active material layer. The fourth information includes at least one of the winding stack number, the product model, the winding stack length, the production time, the production equipment, the production personnel, the number of electrode plates in an electrode plate winding stack, or the electrode plate length.

In the battery information generation system provided in some embodiments of this application, in the first stage, the first identifier generation apparatus generates the first number of first identifiers on the surface of the metal foil at the first intervals, so that a region between the first intervals is divided into the first number of electrode plate regions, and each electrode plate region corresponds to one first identifier. In this way, in the subsequent stage, the information processing apparatus establishes a binding relationship between the electrode plate region information generated in at least one stage and the first identifier, thereby enabling establishment of traceable information in battery production stages by using an electrode plate as a minimum unit, making information traceable to a more detailed level, making it convenient to ascertain quality problems more accurately, improving the yield rate of batteries, reducing scrapped materials in a production process, and reducing production cost of manufacturers.

It is hereby noted that the relational terms herein such as first and second are used only to differentiate an entity or operation from another entity or operation, and do not require or imply any actual relationship or sequence between the entities or operations. Moreover, the terms “include”, “comprise”, and any variation thereof are intended to cover a non-exclusive inclusion relationship in which a process, method, object, or device that includes or comprises a series of elements not only includes such elements, but also includes other elements not expressly specified or also includes inherent elements of the process, method, object, or device.

Different embodiments of this application are described in a correlative manner. For the same or similar part in one embodiment, reference may be made to another embodiment. Each embodiment focuses on differences from other embodiments. In particular, for a system embodiment, since it is basically similar to the method embodiment, the system embodiment is described briefly, and the relevant part may be obtained by referring to the description of the corresponding part in the method embodiment.

What is described above is merely exemplary embodiments of this application, but is not intended to limit this application. Any modifications, equivalent replacements, improvements, and the like made without departing from the spirit and principles of this application still fall within the protection scope of this application.

What is claimed is:

1. A battery information generation method, wherein the method comprises:
a first stage: generating a first number of first identifiers on a surface of a metal foil at first intervals, so that a region between the first intervals is divided into the first number of electrode plate regions, and each electrode plate region corresponds to one first identifier; and obtaining first information of each electrode plate region, and establishing a binding relationship between the each first identifier and the first information of the corresponding electrode plate region; and
a subsequent stage: obtaining stage information of the each electrode plate region in at least one stage separately, and establishing a binding relationship between the first identifier of the at least one stage and the stage information of the corresponding each electrode plate region.

2. The battery information generation method according to claim 1, wherein, in the subsequent stage, the obtaining stage information of the each electrode plate region in at least one stage separately, and establishing a binding relationship between the first identifier of the at least one stage and the stage information of the corresponding each electrode plate region comprise at least one of the following steps:
a second stage: obtaining, after an active material layer is formed in a region between the first intervals, second information on the active material layer in the each electrode plate region, and establishing a binding relationship between the first identifier and the second information of the corresponding each electrode plate region; or
a third stage: obtaining, after an active material layer is cold-pressed, third information on the cold-pressed active material layer in the each electrode plate region, and establishing a binding relationship between the first identifier and the third information of the corresponding each electrode plate region; or
a fourth stage: obtaining, after the metal foil is split into the first number of electrode plate winding stacks along a first direction of the metal foil, fourth information on each electrode plate winding stack to which an electrode plate region belongs, and establishing a binding relationship between the first identifier and the fourth information of the corresponding each electrode plate region.

3. The battery information generation method according to claim 1, wherein the method further comprises an undercoating stage before the first stage, and the undercoating stage comprises: disposing an undercoat in a partial region of a surface of the metal foil, and then, in the first stage, affixing the first identifier onto a surface, uncoated with the undercoat, of the metal foil.

4. The battery information generation method according to claim 1, wherein the method further comprises:
obtaining a winding stack identifier used for identifying a metal foil winding stack, and establishing a binding relationship between the first identifier and the winding stack identifier.

5. The battery information generation method according to claim 1, wherein the generating a first number of first identifiers on a surface of metal foil at first intervals comprises:
setting, in a case that a battery assumes a jelly-roll structure, the first intervals along a first direction of the metal foil, and generating the first number of first identifiers in a first interval along a second direction of the metal foil; or
setting, in a case that a battery assumes a stacked structure, the first intervals along a second direction of the metal foil, and generating the first number of first identifiers in a first interval along a first direction of the metal foil.

6. The battery information generation method according to claim 1, wherein the method further comprises:
generating, after a positive electrode plate and a negative electrode plate are wound or stacked to form an electrode assembly, a second identifier corresponding to the electrode assembly, and establishing a binding relationship between the second identifier and the first identifiers of the positive electrode plate and negative electrode plate that constitute the electrode assembly.

7. The battery information generation method according to claim 1, wherein the generating a first number of first identifiers on a surface of metal foil at first intervals comprises:
generating, by inkjet marking or laser marking, a number of first identifiers in a first region formed by a first interval, wherein the number of first identifiers corresponds to a number of first electrode plate winding stacks into which a metal foil winding stack is slit.

8. The battery information generation method according to claim 2, wherein, in the second stage and/or the third stage, in a case that a mass of the active material layer in a current electrode plate region fails to be obtained, the method further comprises: obtaining, along the first direction of the metal foil, an average value of masses of active material layers in two electrode plate regions adjacent to the current electrode plate region, and using the average value as the mass of the active material layer in the current electrode plate region.

9. The battery information generation method according to claim 2, wherein the method further comprises:
uploading the first information, the binding relationship between the first identifier and the first information of the corresponding electrode plate region, the second information, the binding relationship between the first identifier and the second information of the corresponding electrode plate region, the third information, the binding relationship between the first identifier and the third information of the corresponding electrode plate region, the fourth information, the binding relationship between the first identifier and the fourth information of the corresponding electrode plate region, metal foil winding stack information, and a binding relationship between the first identifier and a winding stack identifier to a server.

10. The battery information generation method according to claim 2, wherein the first information comprises at least one of a winding stack number, a product model, a winding stack length, production time, production equipment, production personnel, a number of electrode plate winding stacks into which a metal foil winding stack is slit, a total number of electrode plates, or an electrode plate length;
the second information comprises at least one of the winding stack number, the product model, the winding stack length, the production time, the production equipment, the production personnel, the number of electrode plate winding stacks into which a metal foil winding stack is slit, the total number of electrode plates, the electrode plate length, constituents of the active material layer, position coordinates of the active material layer, a coating mass of the active material layer, or a coating thickness of the active material layer;
the third information comprises at least one of the winding stack number, the product model, the winding stack length, the production time, the production equipment, the production personnel, the number of electrode plate winding stacks into which a metal foil winding stack is slit, the total number of electrode plates, the electrode plate length, or position coordinates or a thickness of the cold-pressed active material layer; and
the fourth information comprises at least one of the winding stack number, the product model, the winding stack length, the production time, the production equipment, the production personnel, a number of electrode plates in an electrode plate winding stack, or the electrode plate length.

11. A battery information generation system, wherein the system comprises: a first identifier generation apparatus and an information processing apparatus, wherein
the identifier generation apparatus is configured to generate, in a first stage, a first number of first identifiers on a surface of metal foil at first intervals, so that a region between the first intervals is divided into the first number of electrode plate regions, and each electrode plate region corresponds to one first identifier;
the information processing apparatus is configured to obtain first information of each electrode plate region, and establish a binding relationship between each first identifier and the first information of the corresponding electrode plate region; and
in a subsequent stage, obtain stage information of the electrode plate region in at least one stage separately, and establish a binding relationship between the first identifier of the at least one stage and the stage information of the corresponding electrode plate region.

12. The battery information generation system according to claim 11, wherein the information processing apparatus is further configured to:
obtain, in a second stage, after an active material layer is formed in a region between the first intervals, second information on the active material layer in the electrode plate region, and establish a binding relationship between the first identifier and the second information of the corresponding electrode plate region; or
obtain, in a third stage, after an active material layer is cold-pressed, third information on the cold-pressed active material layer in the electrode plate region, and establish a binding relationship between the first identifier and the third information of the corresponding electrode plate region; or
obtain, in a fourth stage, after the metal foil is split into the first number of electrode plate winding stacks along a first direction of the metal foil, fourth information on each electrode plate winding stack to which an electrode plate region belongs, and establish a binding relationship between the first identifier and the fourth information of the corresponding each electrode plate region.

13. The battery information generation system according to claim 11, wherein the information processing apparatus is further configured to:
obtain a winding stack identifier used for identifying a metal foil winding stack, and establish a binding relationship between the first identifier and the winding stack identifier.

14. The battery information generation system according to claim 11, wherein the first identifier generation apparatus is specifically configured to:
set, in a case that a battery assumes a jelly-roll structure, the first intervals along a first direction of the metal foil, and generate the first number of first identifiers in a first interval along a second direction of the metal foil; or
set, in a case that a battery assumes a stacked structure, the first intervals along a second direction of the metal foil, and generate the first number of first identifiers in a first interval along a first direction of the metal foil.

15. The battery information generation system according to claim 11, wherein the system further comprises a second identifier generation apparatus, configured to generate, after a positive electrode plate and a negative electrode plate are wound or stacked to form an electrode assembly, a second identifier corresponding to the electrode assembly, and establish a binding relationship between the second identifier and the first identifiers of the positive electrode plate and negative electrode plate that constitute the electrode assembly.

16. The battery information generation system according to claim 15, wherein the first identifier generation apparatus and/or the second identifier generation apparatus is an inkjet marking device or a laser marking machine.

17. The battery information generation system according to claim 11, wherein that the information processing apparatus is specifically configured to:
obtain, in the second stage and/or the third stage, in a case that a mass of the active material layer in a current electrode plate region fails to be obtained, an average value of masses of active material layers in two electrode plate regions adjacent to the current electrode plate region along the first direction of the metal foil, and use the average value as the mass of the active material layer in the current electrode plate region.

18. The battery information generation system according to claim 12, wherein the system further comprises:
an information uploading apparatus, configured to upload the first information, the binding relationship between the first identifier and the first information of the corresponding electrode plate region, the second information, the binding relationship between the first identifier and the second information of the corresponding electrode plate region, the third information, the binding relationship between the first identifier and the third information of the corresponding electrode plate region, the fourth information, the binding relationship between the first identifier and the fourth information of the corresponding electrode plate region, metal foil winding stack information, and a binding relationship between the first identifier and a winding stack identifier to a server.

19. The battery information generation system according to claim 12, wherein the first information comprises at least one of a winding stack number, a product model, a winding stack length, production time, production equipment, production personnel, a number of electrode plate winding stacks into which a metal foil winding stack is slit, a total number of electrode plates, or an electrode plate length;
the second information comprises at least one of the winding stack number, the product model, the winding stack length, the production time, the production equipment, the production personnel, the number of electrode plate winding stacks into which a metal foil winding stack is slit, the total number of electrode plates, the electrode plate length, constituents of the active material layer, position coordinates of the active material layer, a coating mass of the active material layer, or a coating thickness of the active material layer;
the third information comprises at least one of the winding stack number, the product model, the winding stack length, the production time, the production equipment, the production personnel, the number of electrode plate winding stacks into which a metal foil winding stack is slit, the total number of electrode plates, the electrode plate length, or position coordinates or a thickness of the cold-pressed active material layer; and
the fourth information comprises at least one of the winding stack number, the product model, the winding stack length, the production time, the production equipment, the production personnel, a number of electrode plates in an electrode plate winding stack, or the electrode plate length.

20. An electrochemical device, comprising a first number of first identifiers, wherein, the battery information can be obtained by scanning the first identifier, and the battery information is generated by the battery information generation method according to claim 1.
